(19) United States
(12) Patent Application Publication
(10) Pub. No.: US 2021/0241277 A1
(43) Pub. Date: Aug. 5, 2021

(54) SYSTEMS AND METHODS FOR MANAGING FRAUDULENT OPERATIONS IN A PLURALITY OF COMPUTING DEVICES

(71) Applicant: Capital One Services, LLC, McLean, VA (US)

(72) Inventors: Reza Farivar, Champaign, IL (US); Mark Watson, Urbana, IL (US); Anh Truong, Champaign, IL (US); Galen Rafferty, Mahomet, IL (US); Vincent Pham, Champaign, IL (US); Jeremy Goodsitt, Champaign, IL (US); Austin Walters, Savoy, IL (US)

(21) Appl. No.: 16/778,583

(22) Filed: Jan. 31, 2020

(51) Int. Cl. G06Q 20/40; G06Q 20/38

(52) U.S. Cl. CPC G06Q 20/4016; G06Q 20/3823; G06Q 20/4093

(57) ABSTRACT

In some embodiments, a method includes receiving operation data about operations performed by computing devices managed by an entity. The operation data is stored in respective data entries of a log data storage on a server managed by an authorizing entity. A set of agents are identified from the entity associated with fraudulent operations in entries of the log data storage having positive fraud indications. A number of instances for each identified agent in the set associated with fraudulent operations are determined. A score is assigned to each agent in the set based on the number of instances that each agent was associated with fraudulent operations. An alert to an administering computing device associated with the entity is generated when the assigned score of at least one agent is greater than a predefined threshold.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC., All Rights Reserved.

### FIELD OF TECHNOLOGY

The present disclosure generally relates computing systems, and more specifically to systems and methods for managing fraudulent operations in a plurality of computing devices.

### BACKGROUND OF TECHNOLOGY

computer network platform/system may include a group of computers (e.g., clients, servers, smart routers) and other computing hardware devices that are linked together through one or more communication channels to facilitate communication and/or resource-sharing, via one or more specifically programmed graphical user interfaces (GUIs) of the present disclosure, among a wide range of users.

### SUMMARY OF DESCRIBED SUBJECT MATTER

In some embodiments, the present disclosure provides an exemplary technically improved computer-based method that includes at least the following steps of:

continuously receiving in real time, by a processor of a server managed by an authorizing entity communicating with a plurality of computing devices managed by an entity over a communication network, operation data about each operation of a plurality of operations that are performed by the plurality of computing devices;

storing, by the processor of the server, the operation data in respective data entries of a log data storage;

wherein each respective operation of the plurality of operations may be performed at a computing device of the plurality of computing devices when a user associated with the authorizing entity uses a unique authorization identifier issued by the authorizing entity to authorize the operation;

wherein the operation data of each respective operation may include:
(i) the unique authorization identifier;
(ii) a timestamp of the operation;
(iii) an identifier of the computing device;
(iv) a location of the computing device;
(v) an agent identifier of an agent associated with the entity that performed the operation on the computing device using the unique authorization identifier of the user; and
(vi) an indication that the operation was determined to be fraudulent after the timestamp of the operation;

continuously identifying in real time, by the processor, using the agent identifier in entries of the log data storage having positive fraud indications, a set of agents from the entity associated with fraudulent operations;

continuously determining in real time, by the processor, a number of instances for each identified agent in the set associated with fraudulent operations;

continuously updating in real time, by the processor, a score assigned to each agent in the set based on the number of instances that each agent was associated with fraudulent operations, and based on entries in the log data storage having positive fraud indications with timestamps within a predefined time interval; and

generating, by the processor, an alert to an administering computing device associated with the entity when the assigned score of at least one agent is greater than a predefined threshold.

In some embodiments, the present disclosure provides an exemplary technically improved computer-based system that includes at least the following components of a memory and a processor. The processor of a server may be managed by an authorizing entity communicating with a plurality of computing devices managed by an entity over a communication network;

wherein the processor of the server may be configured to:

continuously receive in real time, operation data about each operation of a plurality of operations that are performed by the plurality of computing devices;

store the operation data in respective data entries of a log data storage;

wherein each respective operation of the plurality of operations may be performed at a computing device of the plurality of computing devices when a user associated with the authorizing entity uses a unique authorization identifier issued by the authorizing entity to authorize the operation;

wherein the operation data of each respective operation comprises:
(i) the unique authorization identifier;
(ii) a timestamp of the operation;
(iii) an identifier of the computing device;
(iv) a location of the computing device;
(v) an agent identifier of an agent associated with the entity that performed the operation on the computing device using the unique authorization identifier of the user; and
(vi) an indication that the operation was determined to be fraudulent after the timestamp of the operation;

continuously identify in real time using the agent identifier in entries of the log data storage having positive fraud indications, a set of agents from the entity associated with fraudulent operations;

continuously determine in real time, a number of instances for each identified agent in the set associated with fraudulent operations;

continuously update in real time, a score assigned to each agent in the set based on the number of instances that each agent was associated with fraudulent operations, and based on entries in the log data storage having positive fraud indications with timestamps within a predefined time interval; and

generate an alert to an administering computing device associated with the entity when the assigned score of at least one agent is greater than a predefined threshold.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of a system for managing fraudulent operations in a plurality of computing devices, in accordance with one or more embodiments of the present disclosure;

FIG. 2 is a diagram of a plurality of computing devices at multiple locations of an entity monitored for fraudulent activities, in accordance with one or more embodiments of the present disclosure;

FIG. 3 is a diagram of a plurality of entity servers for managing for fraudulent activities, in accordance with one or more embodiments of the present disclosure;

FIG. 4 is a flowchart of a method for managing fraudulent operations in a plurality of computing devices, in accordance with one or more embodiments of the present disclosure;

FIG. 5 depicts a block diagram of an exemplary computer-based system/platform in accordance with one or more embodiments of the present disclosure;

FIG. 6 depicts a block diagram of another exemplary computer-based system/platform in accordance with one or more embodiments of the present disclosure; and

FIGS. 7 and 8 are diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “continuously” may refer to events and/or actions that are uninterrupted in time, without cessation, and/or being in immediate connection, such as in periodic time intervals.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

Embodiments of the present disclosure herein describe systems and methods for managing fraudulent operations in a plurality of computing devices managed by an entity. A plurality of computing devices may communicate with an entity server in a computing system managed by the entity, such as a business or retail chain. Each computing device in the plurality of computing devices may by operated by a respective agent in a plurality of agents. Each agent in the plurality of agents may perform operations in the computing system of the entity using the computing device.

In some embodiments, an authorizing entity server managed by an authorizing entity may communicate with the entity server and/or the plurality of computing devices over the communication network. The authorizing entity server may receive operation data about each operation that are performed by the plurality of agents using the plurality of computing devices. Some of the operations performed by the agents may be identified as a fraudulent operation. The authorizing entity server may be configured to analyze the received operation data from the plurality of computing devices to identify a set of agents from the plurality of agents associated with fraudulent operations and to alert administering computing device of an administrator of the entity agents about the agents in the set of agents associated with the fraudulent operations.

The entity may be a merchant or a retail store chain, for example, and the operations may refer to the purchase of goods and/or services from the entity, for example. The term “entity” may refer to a person, an individual, a group of individuals, a partnership, an organization, and/or a business. The entity may perform operations or transactions with users, such as customers of the entity, on computing terminals managed by at least one entity server over the communication network.

The authorizing entity may refer to an entity that is designated as a trusted or authoritative entity of a network of entities, where the network of entities may manage respective computing servers and/or computing devices that communicate over a communication network. The authorizing entity may be entrusted with one or more exclusive roles, such as generating electronic certificates and/or designations identifying permitted activities and/or operations permitted within the computing servers and/or computing devices of the network of entities communicating over the communication network. The term “authorizing entity” may be refer to a financial institution or bank, for example.

In some embodiments, each of the plurality of computing devices may be a point of sale (POS) terminal operated by the agent, such as a store clerk or cashier on a checkout line. An operation performed by the agent at the computing device may be a transaction whereby a user may purchase good and/or services from a merchant and/or a retail store chain. The user may have an account, such as a credit card and/or debit card account, for example, managed by the authorizing entity, such as a financial institution or bank, which may approve or reject the transaction at the POS terminal. The user may use a unique authorization identifier such as credit card and/or debit card number associated with the user's account with the authorizing entity to complete the transaction at the POS terminal.

In some embodiments, some operations of the plurality of operations (e.g., user credit and/or debit card transactions) may be identified as fraudulent. For example, the user may be a criminal or fraudster that stole or intercepted the unique authorization identifier (e.g., credit or debit card number) of the real user and used the unique authorization identifier to perform the fraudulent transaction. The real user may later discover the fraudulent use of the user's credit and/or debit card and report the fraudulent transaction to the authorizing entity. The authorizing entity may place an indication of fraud in the data entry in the operation data corresponding to the fraudulent operation.

In some embodiments, the agent at the POS terminal may typically follow security policies for managing the unique authorization identifiers of users. For example, the agent may check the signature of the user on the credit or debit card against the signature on a transaction receipt and/or request identification from the user to ensure to help prevent fraudulent operations by identifying the user and/or the user's signature on the ID before using the unique authorization identifier of the user to perform the operations at a computing device of the entity. However, if the authorizing entity server determines that a number of instances that a specific agent may be associated with fraudulent operations exceeds a predefined threshold number, this may indicate that the specific agent may be lax in following the security policies for managing the unique authorization identifiers of users and/or the specific agent may be in cahoots with the criminals and/or fraudsters.

In some embodiments, the authorizing entity server may issue an alert to an administrator of the entity, such as a person managing the plurality of agents, for example, that at least one specific agent is involved with the fraudulent operations.

Although some exemplary embodiments taught herein may relate to managing fraudulent transactions by users using credit and/or debit cards in a computing system of a merchant, this is not by way of limitation of the embodiments taught herein. Exemplary embodiments may be applied to any scenario where some agents in a plurality of agents or some computing device operators in a plurality of computing device operators may perform unauthorized or fraudulent operations on the computing devices in the computing system of the entity.

Exemplary embodiments herein provide a technical solution to the technical problem of identifying and managing errant agents where the entity may be unaware of the activities of the errant agents. The computing systems as described herein may be configured to monitor agents in real time that perform a plurality of operations at computing devices managed by the entity when a user associated uses a unique authorization identifier issued by the authorizing entity to authorize the operation performed by the agent, and to detect the errant agents.

The term errant agent herein may refer to a specific agent from a plurality of agents that is lax in following the security policies for managing the unique authorization identifiers of users, that intentionally and/or unintentionally mishandles unique authorization identifiers and/or personal data of users, and/or that may be in cahoots with criminals and/or fraudsters for performing fraudulent transactions using the unique authorization identifiers of users.

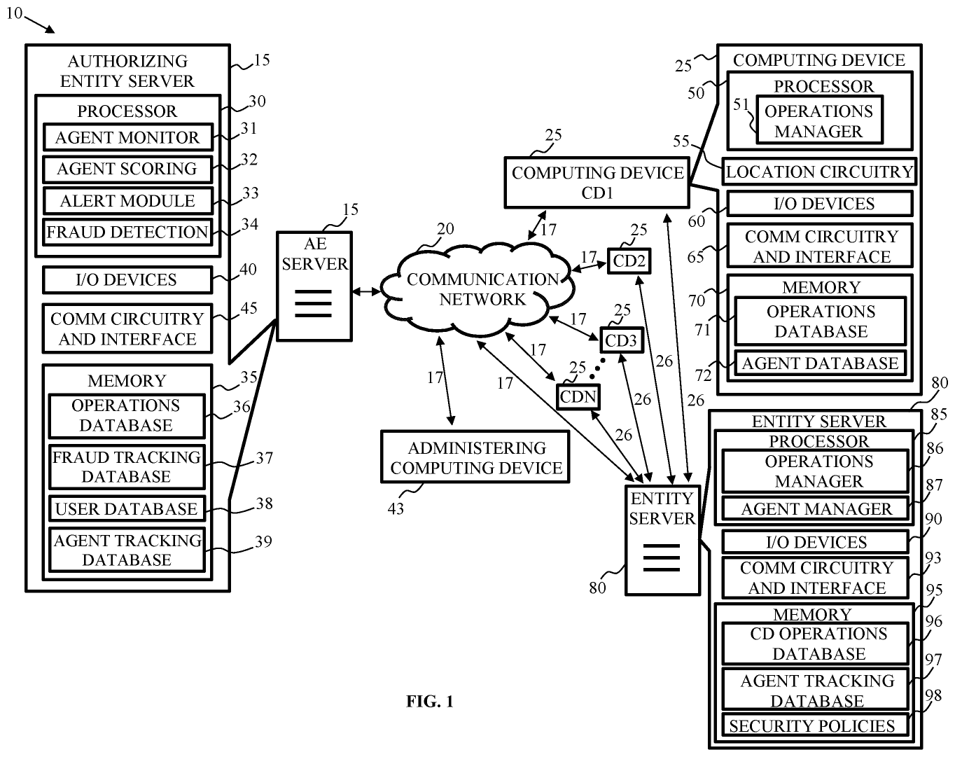

FIG. 1 depicts a block diagram of a system 10 for managing fraudulent operations in a plurality of computing devices 25, in accordance with one or more embodiments of the present disclosure. System 10 may include an authorizing entity (AE) server 15, an entity server 80, an administering computing device 43, and plurality of computing devices 25 denoted CD1, CD2, . . . CDN 25 communicating 26 with entity server 80, where N is an integer, all communicating 17 over a communication network 20.

In some embodiments, AE server 15 may include a processor 30, input/output (I/O) devices 40, a memory 35, and communication circuitry and interface 45 for AE server 15 to communicate over communication network 20.

In some embodiments, memory 35 may include an operations database 36 for storing operation data in respective data entries about each operation in a plurality of operations performed at any of the plurality of computing devices 25. For example, any transaction performed by a cashier in any of the POS terminals (e.g., computing devices 25) may be stored in operations database 36. Memory 35 may include a fraud tracking database 37 for providing an indication such as a data entry in the fraud tracking database 37 indicating that any of the operations stored in the data entries of operations database 36 may be fraudulent. Memory 35 may include a user database 38 for storing data and/or personal data about the users, such as clients of the authorizing entity.

For example, when the authorizing entity is a financial institution, user database 38 may be a client database storing the client personal details, account numbers and respective unique authorization identifiers, such as credit and/or debit card numbers issued by the financial institution to clients. An agent tracking database 39 may be used for storing data and/or personal data about the plurality of agents that performs operations on any of the plurality of computing devices 25 including agents identified as being involved with fraudulent activities.

In some embodiments, processor 30 may be configured to execute software modules: agent monitoring module 31, agent scoring module 32, alert module 33, and/or fraud detection module 34. Agent monitoring module 31 may be used to identify and determine in real-time, a number of instances that agents in the plurality of agents (e.g., using an agent identifier) in the data entries of the stored operation data may be associated with fraudulent operations. Agent scoring module 32 may be used to assign a score to each agent based on the identified number of instances determined by agent monitoring module 31. Alert module 33 may generate an alert on administering computing device 43 of an administrator of the entity when the number of instances is greater than a predefined threshold such as 5 or 10 instances, for example. A fraud detection module 34 may receive information from a fraud department of the authorizing entity or may use algorithms for detecting fraudulent activities. Fraud detection module 34 may be configured to place an indication on data entries in the operation data stored in operations database 36 that a particular operation using a particular unique authorization identifier of a particular user, and performed by a specific agent of the entity, was determined to be fraudulent.

For example, one or more cashiers in a retail store chain may have executed purchase transactions for customers using customer debit and/or credit cards, where the purchase transactions have been flagged as fraudulent (e.g., by a fraud department of a bank issuing the debit and/or credit card, for example) after the time and data that the transaction was completed’, such as when the credit card is swiped at the POS terminal, for example. Agent monitoring module 31 may count a number of instances that a specific agent was associated with a fraudulent transaction and agent scoring module 32 may be used to assign a score to each agent based on the number of instances.

In some embodiments, the assigned score may be the actual number of instances that a specific agent was associated with a fraudulent transaction. In other embodiments, the assigned score may be a probability that a specific agent is lax in following security procedures for managing unique authorized identifiers of users based on the number of instances that a specific agent was associated with a fraudulent transaction relative to the number of the number of transactions. However, if the number of instances of a specific agent is so much larger than that of other agents identified in a set of agents being associated with fraudulent transactions, such as a factor of 10 or 20 times larger (e.g., order of magnitude larger), for example, the specific agent may be suspected of even being in cahoots or cooperating with criminals and/or fraudsters.

In some embodiments, computing device 25 may include a processor 50, location circuitry 55, such as a global positioning system (GPS), for detecting a location of each computing device, input/output (I/O) devices 60, a memory 70, and communication circuitry and interface 65 for computing device 25 to communicate over communication network 20. Processor 50 of each computing device 25 may be configured to execute an operations manager 51 software module for tracking operations performed by an agent of the entity at the computing device when a user associated with the authorizing entity uses a unique authorizer identifier issued by the authorizing entity to authorize the operation. Memory 70 may include an operations database 71 to store operation data of operations performed on computing device 20, and an agent database 72 to store an agent identifier of an agent associated with the entity that performed the operation on the computing device of the entity using the unique authorization identifier of the user.

In some embodiments, entity server 80 may include a processor 85, input/output (I/O) devices 90, a memory 95, and communication circuitry and interface 93 for computing device 25 to communicate 17 over communication network 20 and to communicate 26 directly with each of the computing devices 25 (e.g., CD1, CD2, CDN). Memory 95 may include a computing device (CD) operations database 96, an agent tracking database 97, and a security policies database 98.

In some embodiments, processor 85 may be configured to execute an operations manager 51 and/or an agent manager 87. Operations manager 51 may manage and coordinate all of functions and operations performed on the plurality of computing devices 25. Operations manager 51 may record the operation data of each respective operation in CD operations database 96. Agent manager 87 may be configured to manage the operations performed by each of the agents at respective computing devices 25. Agent manager 87 may store agent information using agent identifiers of agents associated with each operation performed on any of the plurality of computing devices 25 in agent tracking database 97.

In some embodiments, operations manager 51 and/or agent manager 87 may be configured to periodically or continuously send in real time the data stored in CD operations database 96 and agent tracking database 97 to AE server 15 over communication network 20 and store the data respectively in operations database 36 and agent tracking database 39.

In some embodiments, operations database 36, fraud tracking database 37, user database 38, and agent tracking database 39 may be a same database stored in memory 35.

In some embodiments, the operation data of each respective operation stored in operations database 36 may include the unique authorization identifier of a user used by the agent to perform the operation, a timestamp of the operation, such as a record of the data and time that the operation was performed, an identifier of computing device 25 such as a hardware identification (ID) number, or an internet protocol (IP) address of computing device 25, a location of computing device 25 determined using location circuitry 55, and/or an positive or negative indication, such as a flag in the data entry, for example, that the operation was respectively determined or not to be determined to be fraudulent after the timestamp of the operation.

In some embodiments, agent scoring module 32 may assign scores to agents in a set of agents based on a number of instances that an agent was associated with fraudulent operations using agent identifiers and a positive indication of a fraudulent operation in the operation data entries stored in log data storage (e.g., operations database 36). When agent scoring module 32 determines that the assign score is greater than a predefined threshold, alert module 33 may send an alert to administering computing device 43 that at least one agent associated with fraudulent operations may have been lax in following security policies for managing unique authorization identifiers of users, such as credit and/or debit card numbers, for example. In this case, the at least one agent may be requested, for example, to review the security policies stored in security policies database 98. In other embodiments, the security policy may be the checkout policy of a cashier to check for customer credit card fraud.

In some embodiments, POS terminal (e.g., computing devices 25) may be a hardware system or computing device for processing card payments at locations of a merchant or at branches of a retail store. The POS terminal may be configured to communicate with AE server 15 and/or entity server 80 over communication network 20. Software to read the unique authorization identifier, such as credit and/or card numbers, that may be magnetic strips of credit and debit cards may be embedded in the hardware.

In some embodiments, POS terminal may be a computer with software executed by the processor of the computer for performing all of the functions for managing point-of-sale transactions between customers and merchants.

In some embodiments, POS terminal may be a portable device (i.e., such as not terminals fixed to a location). The POS terminal may be configured for contactless capabilities for emerging forms of mobile payments, representing the next generation of POS systems, such as near field communications (NFC).

Example of POS terminals may include POS terminal systems manufactured by Square Inc., POS terminals using Apple IPAD devices operated by Bindo (Bindo, Inc., New York), POS terminals operated by Lavu (Lavu, Inc, Albuquerque, N. Mex.).

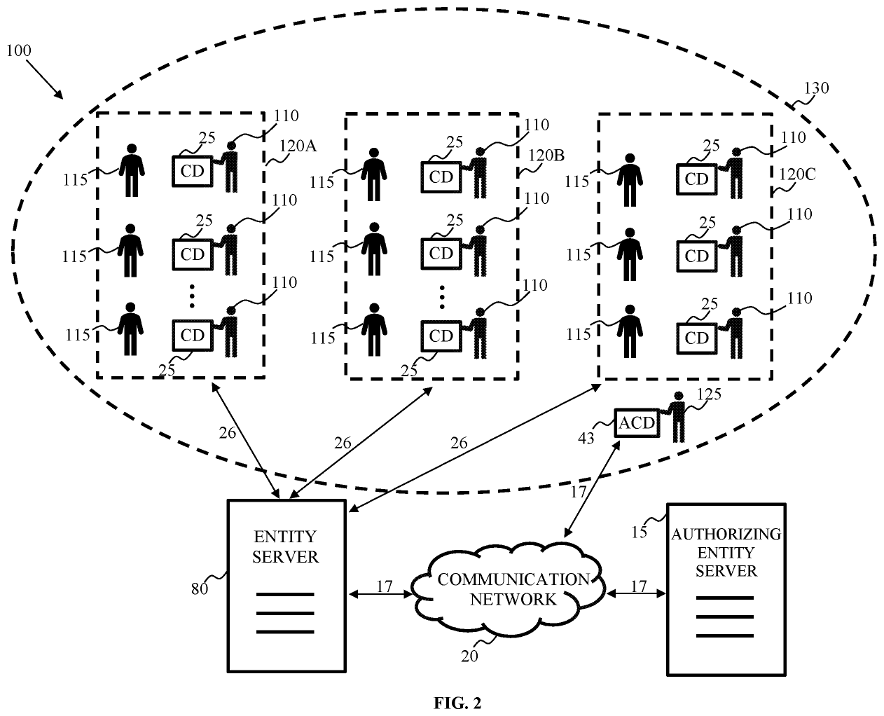

FIG. 2 is a diagram 100 of a plurality of computing devices 25 at multiple locations 120 of an entity 130 monitored for fraudulent activities, in accordance with one or more embodiments of the present disclosure. The plurality of computing devices 25 may located at a plurality of locations as represented by three locations denoted 120A, 120B, and 120C as shown in an exemplary embodiment of FIG. 2, which is merely for conceptual clarity and not by way of limitation of the embodiments shown herein. Any number of computing devices from the plurality of computing devices 25 may be located at any number of locations from the plurality of locations.

In some embodiments, entity 130 may be a retail store chain with multiple branches at different physical locations 120 in a town, a city or a country, for example. Computing device 20 may be a POS terminal. Each agent 110 may be a cashier. A user 115 such as a customer shopping in a branch 120A, for example, may go to an agent 110, to purchase goods that user 115 may wish to purchase in the store. User 115 may hand agent 110 (e.g., the cashier) a credit card with a unique authorization identifier such as a credit card number issued by an authorizing entity. Agent 110 may use the unique authorization identifier of user 115 to perform an operation on computing device (CD) 25.

In some embodiments, entity server 80 communicating 26 with each CD 25 at each location 120 of entity 130 may monitor and manage all of the purchase transactions (e.g., operation data of operations) taking place on each CD 25 in the plurality of computing devices. Entity server 80 may send or relay this purchase transaction information over communication network 20 to AE server 15 for transaction authorization. AE server 15 may register and/or store each operation performed on the plurality of computing devices 25 in entity 130 by the plurality of agents 110 in operations database 36 and/or user database 38.

In some embodiments, agent monitor module 31 may continuously determine in real time, a number of instances that each agent 110 in entity 130 was associated with a fraudulent transaction. Agent monitor module 31 may scan and/or parse each data entry in operations database 36 and/or agent tracking database 39 in real time. Agent monitor module 31 may use the agent identifier, and a positive or negative indication that the operation was determined to be fraudulent, in the operation data for each respective operation performed on the plurality of computing devices 25. Agent score module may assign a score to each agent based on the number of instances using the positive or negative indication that the agent was associated with fraudulent operations. When the assigned score is greater than a predefined threshold, alert module in AE server 15 may send an alert to the administrative computing device 43 of an administrator 125, or a manager, in entity 130 over communicating 17 over communication network 20.

In some embodiments, the assigned score may be the number of instances that the agent was associated with fraudulent operations.

In some embodiments, alert module 33 generating the alert may notify administrator 125 that at least one agent 110 may be lax in following security policies for managing unique authorization identifiers of users 115. The alert may also suggest that a specific agent may be in cahoots with criminals and/or fraudsters.

In some embodiments, alert module 33 may generate the alert to notify administrator 125 that more than one agent 110 at a specific location (e.g., location 120A, location 120B, or location 120C) may be lax in following security policies for managing unique authorization identifiers of users 115.

In some embodiments, alert module 33 may generate the alert to notify administrator 125 that a second server of the entity managing the plurality of computing devices (e.g., entity server 80) may have been breached when processor 30 detects a number of instances of fraudulent operations performed at different computing devices at different locations is greater than a predefined number.

In some embodiments, the authorizing entity may be a financial institution such as a bank.

In some embodiments, the unique authorization identifier issued by the authorizing entity may include a credit card number or a debit card number issued by the financial institution.

In some embodiments, the entity may be a merchant or retail corporation.

In some embodiments, the plurality of operations (e.g., on the plurality of computing devices 25) may include a plurality of transaction between users and the entity, such as between a customer and the merchant, for example.

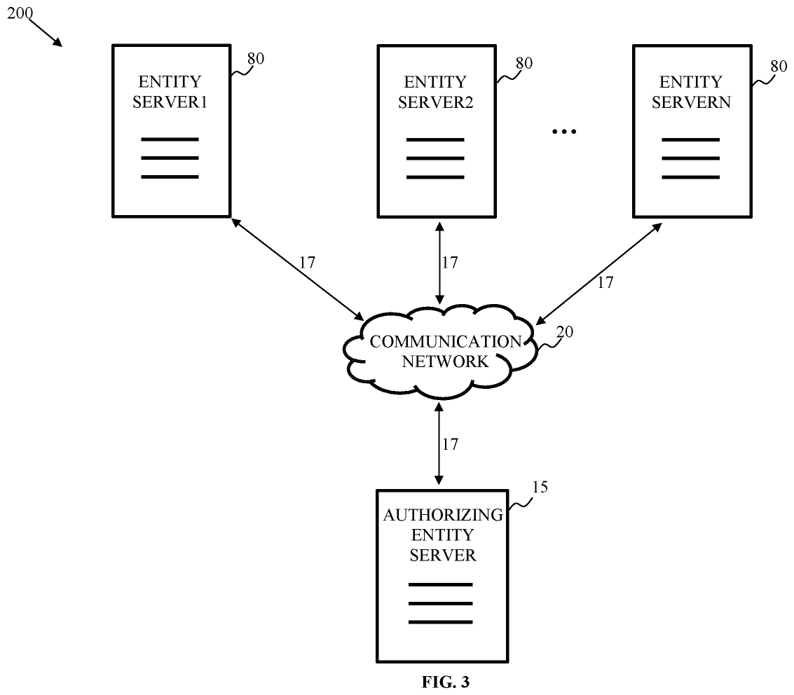

FIG. 3 is a diagram 200 of a plurality of entity servers 80 for managing for fraudulent activities, in accordance with one or more embodiments of the present disclosure. The plurality of entity servers 80 are denoted ENTITY SERVER 1, ENTITY SERVER 2, . . . , ENTITY SERVER N where N is an integer. The plurality of entity servers 80 may each manage a plurality of computing devices 25 of an entity 130 at a plurality of locations 120. Each entity server 80 may communicate 17 over communication network 20 with AE server 15.

In some embodiments, processor 30 of AE server 15 may receive over communication network 20 from other computing devices 25 managed by other entities 80 (e.g., ENTITY SERVER 2, . . . , ENTITY SERVER N) a second number of instances that at least one unique authorization identifier handled by a specific agent identified in the set of agents was used in fraudulent operations performed in the other computing devices of the other entities (e.g., ENTITY SERVER 2, . . . , ENTITY SERVER N). In some embodiments, processor 30 of AE server 15 may send a warning to the administering computing device associated with the entity that the specific agent is suspected of using the at least one unique authorization identifier to perform fraudulent operations.

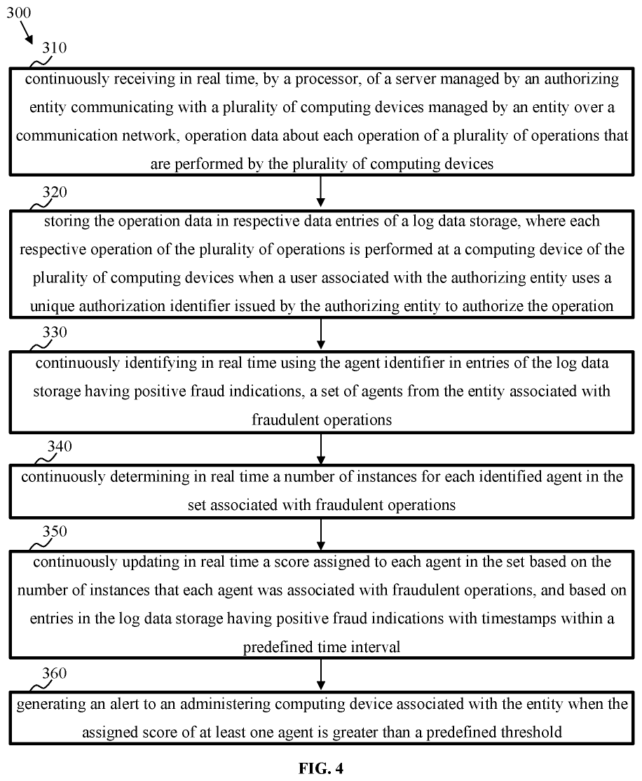

FIG. 4 is a flowchart of a method 300 for managing fraudulent operations in the plurality of computing devices 25, in accordance with one or more embodiments of the present disclosure. Method 300 may be performed by processor 30 of authorizing entity server 15.

Method 300 may include continuously receiving 310 in real time, by a processor, of a server managed by an authorizing entity communicating with a plurality of computing devices managed by an entity over a communication network, operation data about each operation of a plurality of operations that are performed by the plurality of computing devices.

Method 300 may include storing 320 the operation data in respective data entries of a log data storage, where each respective operation of the plurality of operations is performed at a computing device of the plurality of computing devices when a user associated with the authorizing entity uses a unique authorization identifier issued by the authorizing entity to authorize the operation.

Method 300 may include continuously identifying 330 in real time using the agent identifier in entries of the log data storage having positive fraud indications, a set of agents from the entity associated with fraudulent operations.

Method 300 may include continuously determining 340 in real time a number of instances for each identified agent in the set associated with fraudulent operations.

Method 300 may include continuously updating 350 in real time a score assigned to each agent in the set based on the number of instances that each agent was associated with fraudulent operations, and based on entries in the log data storage having positive fraud indications with timestamps within a predefined time interval. For example, processor 30 of authorizing entity server 15 may want to monitor whether a unique authorization identifier and/or a specific agent was involved in a fraudulent operation in the predefined time interval or a sliding time window of 30, 60 or 100 days, for example.

In some embodiments, the assigned score may be ranked and/or normalized to determine if one specific agent maybe involved in many more instances of fraud relative to other agents in the entity.

Method 300 may include generating 360 an alert to an administering computing device associated with the entity when the assigned score of at least one agent is greater than a predefined threshold. For example, if the assigned score is the number of instances that the at least one agent is involved in fraudulent operation in a predefined time interval, processor 30 may generate an alert when the number of instances is greater than 5 or 10 fraudulent operations.

In some embodiments, AE server 15 computing device 25, and/or entity server 80 may store databases as shown in FIG. 1 such operations database 36, fraud tracking database 37, user database 38, and/or agent tracking database 39 for AE server 15, for example, using blockchain technology. Blockchain technology may use cryptographically secured ledgers for storing the operation data and/or unique authorization identifiers, for example, as described in the exemplary embodiments presented herein. Recording the plurality of operations performed at any of the plurality of computing devices 25 may provide an immutable audit trail for those operations and/or transactions. Each of the entities and the authorizing entity may store a copy of the cryptographically secured ledger. The blockchain cryptographically secured ledger further solves the technical problem for providing a “trustless” verification in that no specific authority is needed to verify the integrity of the cryptographically secured ledger or the data stored therein.

In some embodiments, exemplary inventive, specially programmed computing systems/platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a tweet, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) AmigaOS, AmigaOS 4; (2) FreeBSD, NetBSD, OpenBSD; (3) Linux; (4) Microsoft Windows; (5) OpenVMS; (6) OS X (Mac OS); (7) OS/2; (8) Solaris; (9) Tru64 UNIX; (10) VM; (11) Android; (12) Bada; (13) BlackBerry OS; (14) Firefox OS; (15) iOS; (16) Embedded Linux; (17) Palm OS; (18) Symbian; (19) Tizen; (20) WebOS; (21) Windows Mobile; (22) Windows Phone; (23) Adobe AIR; (24) Adobe Flash; (25) Adobe Shockwave; (26) Binary Runtime Environment for Wireless (BREW); (27) Cocoa (API); (28) Cocoa Touch; (29) Java Platforms; (30) JavaFX; (31) JavaFX Mobile; (32) Microsoft XNA; (33) Mono; (34) Mozilla Prism, XUL and XULRunner; (35) .NET Framework; (36) Silverlight; (37) Open Web Platform; (38) Oracle Database; (39) Qt; (40) SAP NetWeaver; (41) Smartface; (42) Vexi; and (43) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RCS, CAST and Skipjack), cryptographic hash algorithms (e.g., MDS, RIPEMD-160, RTR0, SHA-1, SHA-2, Tiger (TTH), WHIRLPOOL, RNGs). The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

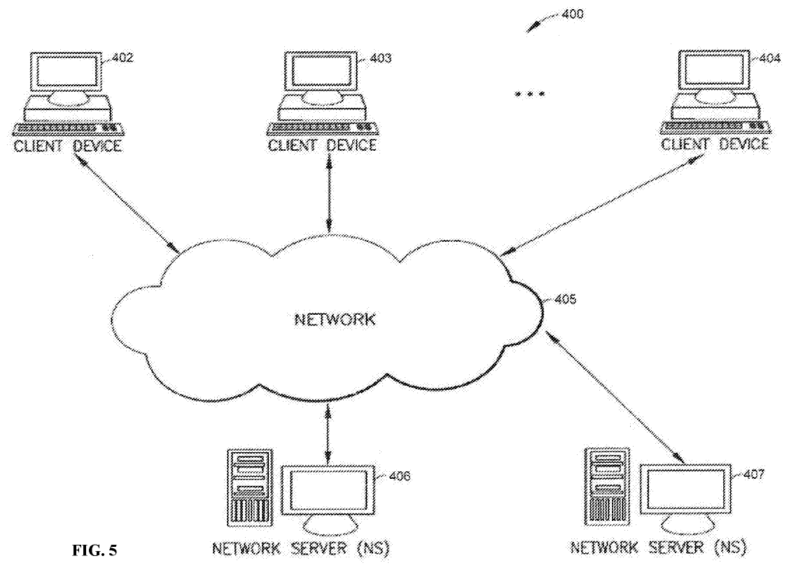

FIG. 5 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 400 may be configured to manage a large number of members and/or concurrent transactions, as detailed herein. In some embodiments, the exemplary computer-based system/platform 400 may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 5, members 402-404 (e.g., clients) of the exemplary computer-based system/platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may include may run one or more applications, such as Internet browsers, mobile applications, voice calls, video games, videoconferencing, and email, among others. In some embodiments, one or more member devices within member devices 402-404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java, .Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 5, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

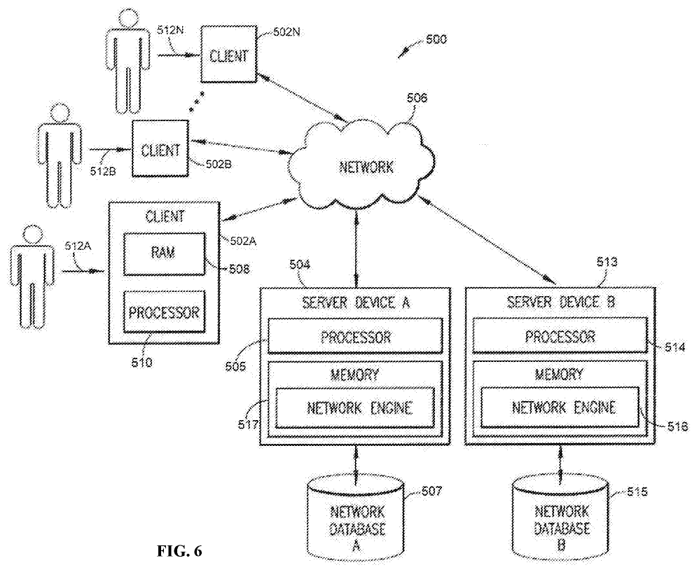

FIG. 6 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, a speaker, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™ Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 512n, may communicate over the exemplary network 506 with each other and/or with other systems and/or devices coupled to the network 506. As shown in FIG. 10, exemplary server devices 504 and 513 may be also coupled to the network 506. In some embodiments, one or more member computing devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

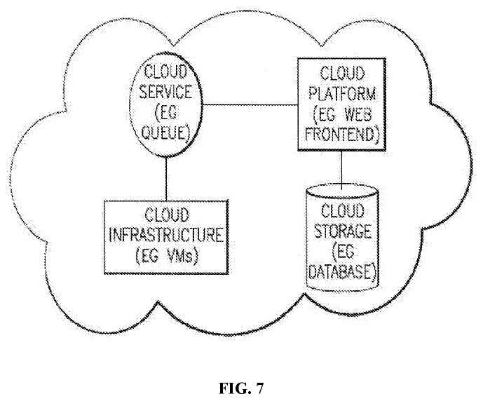

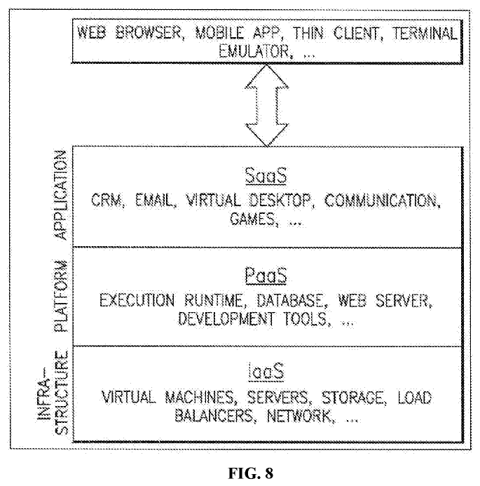

In some embodiments, the exemplary inventive computer-based systems/platforms, the exemplary inventive computer-based devices, and/or the exemplary inventive computer-based components of the present disclosure may be specifically configured to operate in an cloud computing/architecture such as, but not limiting to: infrastructure a service (IaaS), platform as a service (PaaS), and/or software as a service (SaaS). FIGS. 7 and 8 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

At least some aspects of the present disclosure will now be described with reference to the following numbered clauses.

1. A method, comprising:

continuously receiving in real time, by a processor of a server managed by an authorizing entity communicating with a plurality of computing devices managed by an entity over a communication network, operation data about each operation of a plurality of operations that are performed by the plurality of computing devices;

storing, by the processor of the server, the operation data in respective data entries of a log data storage;

wherein each respective operation of the plurality of operations is performed at a computing device of the plurality of computing devices when a user associated with the authorizing entity uses a unique authorization identifier issued by the authorizing entity to authorize the operation;

wherein the operation data of each respective operation comprises:
(i) the unique authorization identifier;
(ii) a timestamp of the operation;
(iii) an identifier of the computing device;
(iv) a location of the computing device;
(v) an agent identifier of an agent associated with the entity that performed the operation on the computing device using the unique authorization identifier of the user; and
(vi) an indication that the operation was determined to be fraudulent after the timestamp of the operation;

continuously identifying in real time, by the processor, using the agent identifier in entries of the log data storage having positive fraud indications, a set of agents from the entity associated with fraudulent operations;

continuously determining in real time, by the processor, a number of instances for each identified agent in the set associated with fraudulent operations;

continuously updating in real time, by the processor, a score assigned to each agent in the set based on the number of instances that each agent was associated with fraudulent operations, and based on entries in the log data storage having positive fraud indications with timestamps within a predefined time interval; and

generating, by the processor, an alert to an administering computing device associated with the entity when the assigned score of at least one agent is greater than a predefined threshold.

2. The method according to clause 1, wherein generating the alert comprises alerting the administering computing device that the at least one agent is lax in following security policies for managing unique authorization identifiers of users.
3. The method according to clause 1, wherein generating the alert comprises alerting the administering computing device that agents at a specific location of the entity are lax in following security policies for using unique authorization identifiers of users when a number of the at least one agent in the set of agents at the specific location is greater than a predefined number.
4. The method according to clause 1, wherein generating the alert comprises alerting the administering computing device that a second server of the entity managing the plurality of computing devices may have been breached when a number of instances of fraudulent operations performed at different computing devices at different locations is greater than a predefined number.
5. The method according to any of the preceding clauses, wherein the authorizing entity comprises a financial institution.
6. The method according to any of the preceding clauses, wherein the unique authorization identifier issued by the authorizing entity comprises a credit card number issued by the financial institution.
7. The method according to any of the preceding clauses, wherein the entity comprises a merchant or retail corporation.
8. The method according to any of the preceding clauses, wherein the plurality of operations comprises a plurality of transactions between users and the entity.
9. The method according to clause 1, further comprising receiving, by the processor over the communication network from other computing devices managed by other entities, a second number of instances that at least one unique authorization identifier handled by a specific agent identified in the set of agents was used in fraudulent operations performed in the other computing devices.
10. The method according to clause 1 or 9, further comprising sending, by the processor, a warning to the administering computing device associated with the entity that the specific agent is suspected of using the at least one unique authorization identifier to perform fraudulent operations.
11. A system, comprising:

a memory; and

a processor of a server managed by an authorizing entity communicating with a plurality of computing devices managed by an entity over a communication network;

wherein the processor of the server is configured to:

continuously receive in real time, operation data about each operation of a plurality of operations that are performed by the plurality of computing devices;

store the operation data in respective data entries of a log data storage;

wherein each respective operation of the plurality of operations is performed at a computing device of the plurality of computing devices when a user associated with the authorizing entity uses a unique authorization identifier issued by the authorizing entity to authorize the operation;

wherein the operation data of each respective operation comprises:
(i) the unique authorization identifier;
(ii) a timestamp of the operation;
(iii) an identifier of the computing device;
(iv) a location of the computing device;
(v) an agent identifier of an agent associated with the entity that performed the operation on the computing device using the unique authorization identifier of the user; and
(vi) an indication that the operation was determined to be fraudulent after the timestamp of the operation;

continuously identify in real time using the agent identifier in entries of the log data storage having positive fraud indications, a set of agents from the entity associated with fraudulent operations;

continuously determine in real time, a number of instances for each identified agent in the set associated with fraudulent operations;

continuously update in real time, a score assigned to each agent in the set based on the number of instances that each agent was associated with fraudulent operations, and based on entries in the log data storage having positive fraud indications with timestamps within a predefined time interval; and

generate an alert to an administering computing device associated with the entity when the assigned score of at least one agent is greater than a predefined threshold.

12. The system according to clause 11, wherein the processor is configured to generate the alert by alerting the administering computing device that the at least one agent is lax in following security policies for managing unique authorization identifiers of users.
13. The system according to clause 11, wherein the processor is configured to generate the alert by alerting the administering computing device that agents at a specific location of the entity are lax in following security policies for using unique authorization identifiers of users when a number of the at least one agent in the set of agents at the specific location is greater than a predefined number.
14. The system according to clause 11, wherein the processor is configured to generate the alert by alerting the administering computing device that a second server of the entity managing the plurality of computing devices may have been breached when a number of instances of fraudulent operations performed at different computing devices at different locations is greater than a predefined number.
15. The system according to clauses 11, 12, 13, or 14, wherein the authorizing entity comprises a financial institution.
16. The system according to clauses 11, 12, 13, 14, or 15, wherein the unique authorization identifier issued by the authorizing entity comprises a credit card number issued by the financial institution.
17. The system according to clauses 11, 12, 13, 14, 15, or 16 wherein the entity comprises a merchant or retail corporation.
18. The system according to clauses 11, 12, 13, 14, 15, 16 or 17, wherein the plurality of operations comprises a plurality of transactions between users and the entity.
19. The system according to clause 11, wherein the processor is further configured to receive over the communication network from other computing devices managed by other entities, a second number of instances that at least one unique authorization identifier handled by a specific agent identified in the set of agents was used in fraudulent operations performed in the other computing devices.
20. The system according to clauses 11 or 19, wherein the processor is further configured to send a warning to the administering computing device associated with the entity that the specific agent is suspected of using the at least one unique authorization identifier to perform fraudulent operations.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

1. A method, comprising:
continuously receiving in real time, by a processor of an authorizing entity server managed by an authorizing entity communicating with a plurality of computing devices managed by at least one entity server of an entity over a communication network, operation data about each operation of a plurality of operations that are performed by the plurality of computing devices;
storing, by the processor of the authorizing entity server, the operation data in respective data entries of a log data storage;
wherein each respective operation of the plurality of operations is performed at a computing device of the plurality of computing devices when a user associated with the authorizing entity uses a unique authorization identifier issued by the authorizing entity to authorize the operation;
wherein the operation data of each respective operation comprises:
(i) the unique authorization identifier;
(ii) a timestamp of the operation;
(iii) an identifier of the computing device;
(iv) a location of the computing device; and
(v) an agent identifier of an agent associated with the entity that performed the operation on the computing device using the unique authorization identifier of the user;
receiving, by the processor of the authorizing entity server, at least one indication that at least one respective particular operation from the plurality of operations was determined to be fraudulent after the timestamp of the at least one particular operation;
storing, by the processor of the authorizing entity server, the at least one the fraudulent indication in the operation data of the respective at least one particular operation;
continuously identifying in real time, by the processor of the authorizing entity server, using the agent identifier in entries of the log data storage having positive fraud indications, a set of agents from the entity associated with fraudulent operations;
continuously determining in real time, by the processor of the authorizing entity server, a number of instances for each identified agent in the set associated with fraudulent operations;
continuously updating in real time, by the processor of the authorizing entity server, a score assigned to each agent in the set based on the number of instances that each agent was associated with fraudulent operations, and based on entries in the log data storage having positive fraud indications with timestamps within a predefined time interval; and
performing, by the processor of the authorizing entity server;
at least one of:
(i) determining that the at least one agent is lax in following security policies of the entity for managing unique authorization identifiers of users when the assigned score of at least one agent is greater than a predefined threshold, and causing over the communication network, at least one computing device from the plurality of computing devices associated with the at least one agent that is lax, to reject operations;
(ii) determining that agents in a specific location of the entity are lax in following the security policies of the entity for managing unique authorization identifiers of users when a number of the at least one agent in the set of agents at the specific location is greater than a predefined first number, and causing over the communication network, a first subset of computing devices from the plurality of computing devices associated with agents in the specific location of the entity that are lax, to reject operations; or
(iii) determining that the at least one entity server is breached when the number of instances for each identified agent in the set associated with fraudulent operations performed at different computing devices at different locations of the entity is greater than a second predefined number, and causing over the communication network, a second subset of computing devices from the plurality of computing devices associated with the at least one entity server that is breached, to reject operations;
sending, by the processor of the authorizing entity server over the communication network, an alert to an administering computing device associated with the entity about the rejected operations; and
identifying, by the processor of the authorizing entity server, data of the at least one agent that is lax in following security policies of the entity.

2. (canceled)

3. (canceled)

4. (canceled)

5. The method according to claim 1, wherein the authorizing entity comprises a financial institution.

6. The method according to claim 5, wherein the unique authorization identifier issued by the authorizing entity comprises a credit card number issued by the financial institution.

7. The method according to claim 1, wherein the entity comprises a merchant or retail corporation.

8. The method according to claim 1, wherein the plurality of operations comprises a plurality of transactions between users and the entity.

9. The method according to claim 1, further comprising receiving, by the processor over the communication network from other computing devices managed by other entities, a second number of instances that at least one unique authorization identifier handled by a specific agent identified in the set of agents was used in fraudulent operations performed in the other computing devices.

10. The method according to claim 9, further comprising sending, by the processor, a warning to the administering computing device associated with the entity that the specific agent is suspected of using the at least one unique authorization identifier to perform fraudulent operations.

11. A system, comprising:
a memory; and
a processor of an authorizing entity server managed by an authorizing entity communicating with a plurality of computing devices managed by at least one entity server of an entity over a communication network;
wherein the processor of the authorizing entity server is configured to:
continuously receive in real time, operation data about each operation of a plurality of operations that are performed by the plurality of computing devices;
store the operation data in respective data entries of a log data storage;
wherein each respective operation of the plurality of operations is performed at a computing device of the plurality of computing devices when a user associated with the authorizing entity uses a unique authorization identifier issued by the authorizing entity to authorize the operation;
wherein the operation data of each respective operation comprises:
(i) the unique authorization identifier;
(ii) a timestamp of the operation;
(iii) an identifier of the computing device;
(iv) a location of the computing device; and
(v) an agent identifier of an agent associated with the entity that performed the operation on the computing device using the unique authorization identifier of the user;
receive at least one indication that at least one respective particular operation from the plurality of operations was determined to be fraudulent after the timestamp of the at least one particular operation;
store the at least one the fraudulent indication in the operation data of the respective at least one particular operation;
continuously identify in real time using the agent identifier in entries of the log data storage having positive fraud indications, a set of agents from the entity associated with fraudulent operations;
continuously determine in real time, a number of instances for each identified agent in the set associated with fraudulent operations;
continuously update in real time, a score assigned to each agent in the set based on the number of instances that each agent was associated with fraudulent operations, and based on entries in the log data storage having positive fraud indications with timestamps within a predefined time interval; and
perform
at least one of:
(i) determine that the at least one agent is lax in following security policies of the entity for managing unique authorization identifiers of users when the assigned score of at least one agent is greater than a predefined threshold, and cause over the communication network, at least one computing device from the plurality of computing devices associated with the at least one agent that is lax, to reject operations;
(ii) determine that agents in a specific location of the entity are lax in following the security policies of the entity for managing unique authorization identifiers of users when a number of the at least one agent in the set of agents at the specific location is greater than a predefined first number, and cause over the communication network, a first subset of computing devices from the plurality of computing devices associated with agents in the specific location of the entity that are lax, to reject operations; or
(iii) determine that the at least one entity server is breached when the number of instances for each identified agent in the set associated with fraudulent operations performed at different computing devices at different locations of the entity is greater than a second predefined number, and cause over the communication network, a second subset of computing devices from the plurality of computing devices associated with the at least one entity server that is breached, to reject operations;
send over the communication network, an alert to an administering computing device associated with the entity about the rejected operations; and
identify data of the at least one agent that is lax in following security policies of the entity.

12. (canceled)

13. (canceled)

14. (canceled)

15. The system according to claim 11, wherein the authorizing entity comprises a financial institution.

16. The system according to claim 15, wherein the unique authorization identifier issued by the authorizing entity comprises a credit card number issued by the financial institution.

17. The system according to claim 11, wherein the entity comprises a merchant or retail corporation.

18. The system according to claim 11, wherein the plurality of operations comprises a plurality of transactions between users and the entity.

19. The system according to claim 11, wherein the processor is further configured to receive over the communication network from other computing devices managed by other entities, a second number of instances that at least one unique authorization identifier handled by a specific agent identified in the set of agents was used in fraudulent operations performed in the other computing devices.

20. The system according to claim 19, wherein the processor is further configured to send a warning to the administering computing device associated with the entity that the specific agent is suspected of using the at least one unique authorization identifier to perform fraudulent operations.

21. The method according to claim 1, wherein receiving the at least one indication that the at least one respective particular operation from the plurality of operations was determined to be fraudulent comprises receiving information electronically over the communication network from a fraud department of the authorizing entity that the at least one particular operation was determined to be fraudulent.

22. The system according to claim 11, further comprising a fraud detection module, and wherein the processor is configured to receive the at least one indication that the at least one respective particular operation from the plurality of operations was determined to be fraudulent by receiving information electronically by the fraud detection module over the communication network from a fraud department of the authorizing entity that the at least one particular operation was determined to be fraudulent.
